(19) United States
(12) Patent Application Publication
(10) Pub. No.: US 2008/0238827 A1
(43) Pub. Date: Oct. 2, 2008

(54) PLASMA DISPLAY PANEL AND METHOD FOR MANUFACTURING THE SAME

(76) Inventors: Jong-woo Choi, Suwon-si (KR); Won-ju Yi, Suwon-si (KR); Kyoung-doo Kang, Suwon-si (KR); Yong-shik Hwang, Suwon-si (KR); Jae-ik Kwon, Suwon-si (KR); Tae-seung Cho, Suwon-si (KR); Hyun-min Son, Suwon-si (KR); Byoung-min Chun, Suwon-si (KR); Young-do Choi, Suwon-si (KR)

Correspondence Address: CHRISTIE, PARKER & HALE, LLP, PO BOX 7068, PASADENA, CA, 91109-7068, US

(21) Appl. No.: 12/014,038

(22) Filed: Jan. 14, 2008

(30) Foreign Application Priority Data
Mar. 27, 2007 (KR) 10-2007-0029838

(51) Int. Cl. G09G 3/28; H01J 9/20

(52) U.S. Cl. 345/66; 445/24

(57) ABSTRACT

A plasma display panel, and a method for manufacturing the same. The plasma display panel includes a first electrode sheet between a first substrate and a second substrate facing the first substrate; and a second electrode sheet between the second substrate and the first electrode sheet. The first electrode sheet includes a plurality of first inner lines, each of the first inner lines including a first discharge electrode and a first dielectric layer enclosing the first discharge electrode and composed of an anodized material of the first discharge electrode, the second electrode sheet includes a plurality of second inner lines, each of the second inner lines including a second discharge electrode and a second dielectric layer enclosing the second discharge electrode and composed of an anodized material of the second discharge electrode.

### CROSS-REFERENCE TO RELATED APPLICATIONS

This application claims priority to and the benefit of Korean Patent Application No. 10-2007-0029838 filed on Mar. 27, 2007, in the Korean Intellectual Property Office, the entire content of which is incorporated herein by reference.

### BACKGROUND

1. Field of the Invention

The present invention relates to a plasma display panel, and more particularly to a plasma display panel including an anodized electrode sheet, and a method for manufacturing the same.

2. Discussion of Related Art

A plasma display panel (referred to as ‘PDP’ hereinafter) can be classified as a direct current (DC) PDP, an alternating current (AC) PDP, or a hybrid type PDP depending upon the applied discharge voltage.

Additionally, the PDP may be classified as a facing (or opposing) discharge PDP or a surface discharge PDP depending on its discharge structure.

In a DC PDP, the electrodes are exposed in a discharge space, and electrical charges move directly between electrodes to generate a discharge. In an AC PDP, because a dielectric layer covers at least one electrode and a passivation layer such as magnesium oxide (MgO) covers the dielectric layer, electrical charges do not move directly between oppositely facing electrodes. Instead, a discharge is achieved by utilizing wall charges.

In the DC PDP, since charges are directly transferred between oppositely facing electrodes, the electrodes can be severely damaged. Accordingly, the AC PDP has been more widely used.

In the AC PDP, a discharge space is defined by a front substrate, a rear substrate, and a partition. Also, in the case of the AC PDP, an AC type 3 electrode surface discharge structure has been developed. The AC type 3 electrode surface discharge PDP has a first discharge electrode, an X electrode, and a Y electrode.

However, in the AC type 3 electrode surface discharge PDP, during an address discharge, a discharge path between the first discharge electrode and the X or Y electrode is long, thereby requiring a relatively high address discharge voltage. Furthermore, the address voltage becomes relatively hard to sustain (or maintain).

Accordingly, there is a need for a PDP to have an improved electrode structure.

### SUMMARY OF THE INVENTION

Aspects of embodiments of the present invention are directed toward a plasma display panel, which prevents (or blocks) discharge from occurring in a non-discharge region of an electrode sheet formed by anodization, and includes a passivation layer at a surface of a dielectric layer of an electrode sheet, and a method for manufacturing the same.

In one embodiment, a plasma display panel includes a first electrode sheet between a first substrate and a second substrate facing the first substrate; and a second electrode sheet disposed between the second substrate and the first electrode sheet, wherein the first electrode sheet includes a plurality of first inner lines, each of the first inner lines including a first discharge electrode and a first dielectric layer enclosing the first discharge electrode and being composed of an anodized material of the first discharge electrode, the first discharge electrode including a plurality of first discharge portions and a first connection portion coupling the first discharge portions along a first direction, each of the first discharge portions having a first closed curve surrounding a first discharge hole through the first closed curve, wherein the second electrode sheet includes a plurality of second inner lines, each of the second inner lines including a second discharge electrode and a second dielectric layer enclosing the second discharge electrode and being composed of an anodized material of the second discharge electrode, the second discharge electrode including a plurality of second discharge portions and a second connection portion coupling the second discharge portions along a second direction crossing the first direction, each of the second discharge portions having a second closed curve surrounding a second discharge hole through the second closed curve, and wherein the first electrode sheet and the second electrode sheet are arranged so that the first discharge hole corresponds with the second discharge hole; and a plurality of dielectric structures at non-discharge spaces of the first electrode sheet and the second electrode sheet.

In one embodiment, a plasma display panel includes a first substrate; a second substrate facing the first substrate; a first discharge electrode between the first substrate and the second substrate; a first dielectric layer on the first substrate and covering the first discharge electrode; and an electrode sheet disposed between the first substrate and the second substrate, wherein the electrode sheet includes a plurality of inner lines and an edge line, each of the inner lines including a second discharge electrode and a second dielectric layer enclosing the second discharge electrode and being composed of an anodized material of the second discharge electrode, the second discharge electrode including a plurality of discharge portions and a connection portion electrically connecting the discharge portions along a one direction, each of the discharge portions having a closed curve surrounding a discharge hole through the closed curve, the edge line forming an edge of the electrode sheet to couple ends of the inner lines; and a plurality of dielectric structures at non-discharge spaces between the inner lines of the electrode sheet, and between the edge line and the inner lines.

In one embodiment, method for manufacturing a plasma display panel includes an anodized electrode sheet, the method including: cutting at least one metal sheet; anodizing the metal sheet to form an electrode sheet including a plurality of inner lines and an edge line, the plurality of inner lines including a discharge electrode and a dielectric layer enclosing the discharge electrode and being composed of an anodized material of the discharge electrode, the discharge electrode including a plurality of discharge portions, each of the discharge portions having a closed curve surrounding a discharge hole through the closed curve and a connection portion for electrically connecting the discharge portions along one direction, the edge line forming an edge of the electrode sheet to couple ends of the inner lines; positioning the electrode sheet on a first substrate; forming a plurality of dielectric structures at non-discharge spaces between the inner lines of the electrode sheet, and between the edge line and the inner lines; and adhering a second substrate to the first substrate and the electrode sheet.

Since the plasma display panel according to the present invention uses an anodized electrode, the manufacturing process is simplified. Further, discharge occurring in the non-discharge region is prevented (or blocked) to improve discharge efficiency. Also, a passivation layer is formed on a dielectric layer to enhance a passivation function.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 an exploded perspective view showing a plasma display panel according to a first embodiment of the present invention;

FIG. 2 is a transverse cross-sectional view of the plasma display panel shown in FIG. 1;

FIG. 3A is a perspective view showing a first electrode sheet shown in FIG. 1;

FIG. 3B is an enlarged view of a peripheral portion of a unit discharge hole in the first electrode sheet shown in FIG. 3A;

FIG. 3C is a cross-sectional view of the peripheral portion of the unit discharge hole taken along line I-I′ of FIG. 3A;

FIG. 4A is a perspective view showing a second electrode sheet shown in FIG. 1;

FIG. 4B is an enlarged view of a peripheral portion of a unit discharge hole in the second electrode sheet shown in FIG. 4A;

FIG. 4C is a cross-sectional view of the peripheral portion of the unit discharge hole taken along line I-I′ of FIG. 4A;

FIG. 5 is an enlarged perspective view showing an electrode sheet;

FIGS. 6A, 6B, 6C, 6D, and 6E are cross-sectional views showing a method for manufacturing a plasma display panel according to an embodiment of the present invention;

FIG. 7 is a partially perspective view showing a plasma display panel according to a second embodiment of the present invention; and

FIG. 8 is a cross-sectional view of the plasma display panel taken along line A-A′ of FIG. 7.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

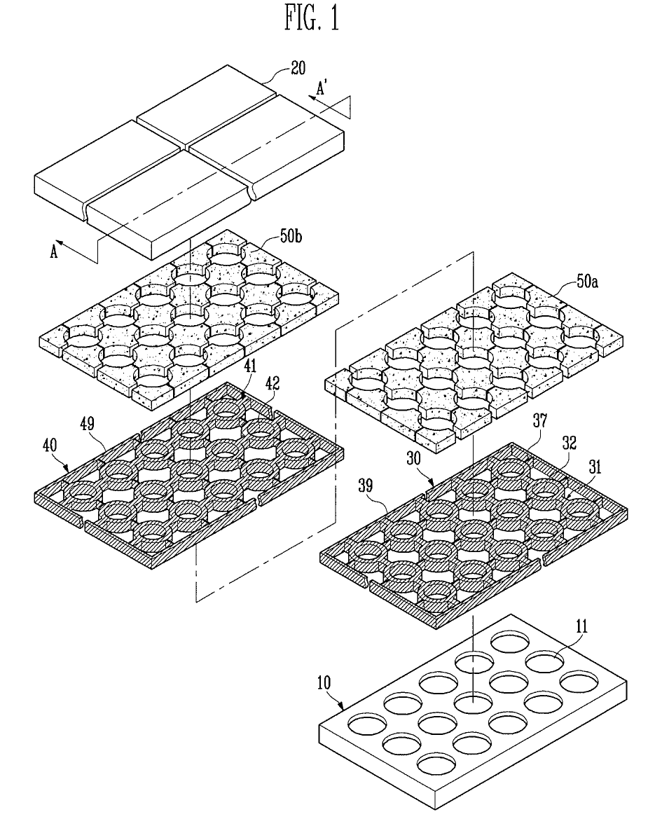

FIG. 1 is an exploded perspective view showing a plasma display panel according to a first embodiment of the present invention. FIG. 2 is a transverse cross-sectional view of the plasma display panel shown in FIG. 1.

The plasma display panel according to the first embodiment of the present invention includes a rear substrate 10, a front substrate 20, a first electrode sheet 30, a second electrode sheet 40, and dielectric structures 50a and 50b.

The rear substrate 10 and the front substrate 20 are spaced apart from each other by a distance (that may be predetermined) therebetween. The first electrode sheet 30 and the second electrode sheet 40 are disposed between the rear substrate 10 and the front substrate 20.

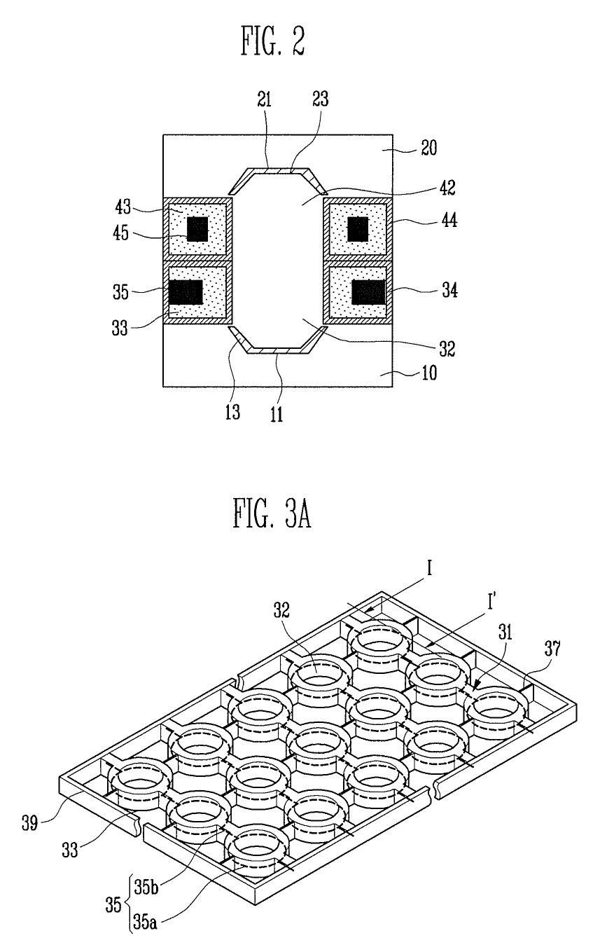

As shown in FIGS. 3A and 3B, the first electrode sheet 30 includes a plurality of first inner lines 31, a first bridge line 37, and a first edge line 39. Each of the first inner lines 31 includes a first dielectric layer 33 and a first discharge electrode 35. The first bridge line 37 connects the first inner lines 31 to each other. The first edge line 39 couples ends of the first inner lines 31 and an end of the first bridge line 37. A plurality of discharge holes 32 are formed through the first inner lines 31.

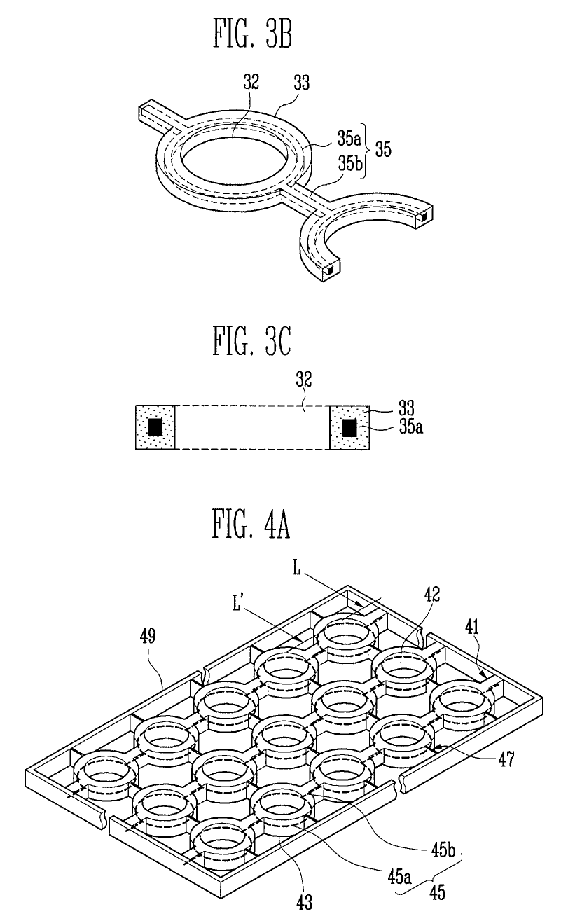

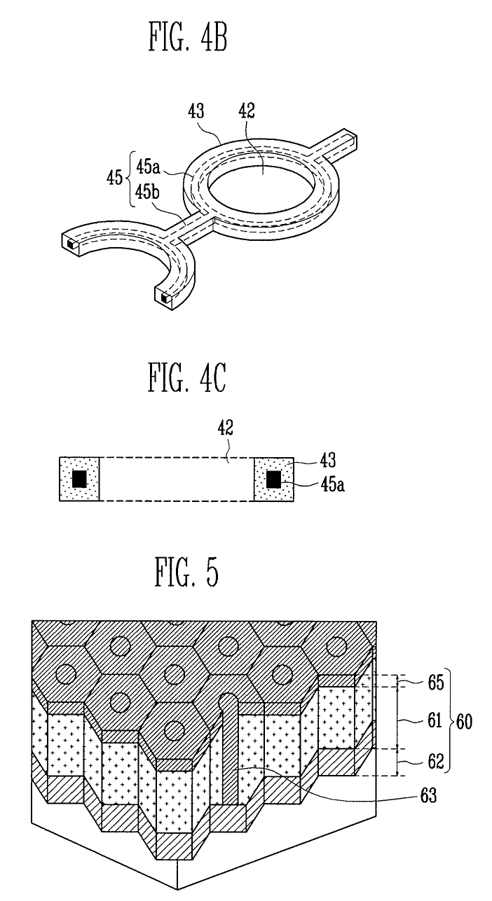

As shown in FIGS. 4A and 4B, the second electrode sheet 40 includes a plurality of second inner lines 41, a second bridge line 47, and a second edge line 49. Each of the second inner lines 41 includes a second dielectric layer 43 and a second discharge electrode 45. The second bridge line 47 connects the second inner lines 41 to each other. The second edge line 49 couples ends of the second inner lines 41 and an end of the second bridge line 47. A plurality of discharge holes 42 are formed through the second inner lines 41.

Accordingly, each discharge space of the first embodiment of the present invention is defined by using the rear substrate 10 as a lower surface, the front substrate 20 as an upper surface, and one of the first discharge holes 32 and a corresponding one of the second discharge holes 42 formed through the first electrode sheet 30 and the second electrode sheet 40, respectively, as the inner wall surfaces. An inside of the discharge space is filled with a discharge gas.

Also, as shown in FIG. 2, a first groove 11 and a second groove 21 are respectively formed in the rear substrate 10 and the front substrate 20. The discharge space is defined between the rear substrate 10 and the front substrate 20. The first groove 11 and the second groove 21 are etched to a depth that may be predetermined. First and second fluorescent layers 13 and 23 are formed in the first groove 11 and the second groove 21, respectively. Here, in the first embodiment of the present invention, the grooves 11 and 21 are provided to form the fluorescent layers 13 and 23 at respective sides of the rear substrate 10 and the front substrate 20.

As such, a discharge between the first discharge electrode 35 of the first electrode sheet 30 and the second discharge electrode 45 of the second electrode sheet 40 by an external power source drives the plasma display panel. Here, the first discharge electrode 35 and the second discharge electrode 45 are respectively included in the first electrode sheet 30 and the second electrode sheet 40.

For example, when the external power source is applied to the first discharge electrode 35 and the second discharge electrode 45, the first discharge electrode 35 functions as a scan electrode and a Y electrode, and the second discharge electrode 45 functions as an address electrode and an X electrode, thereby driving the plasma display panel.

Referring to the FIGS. 3A, 3B, and 3C, a construction of the first electrode sheet 30 will be now described in more detail. FIG. 3A is a perspective view showing the first electrode sheet shown in FIG. 1 according to an embodiment of the present invention. FIG. 3B is an enlarged view of a peripheral portion of a unit discharge hole in the first electrode sheet shown in FIG. 3A. FIG. 3C is a cross-sectional view of the peripheral portion of the unit discharge hole taken along line I-I′ of FIG. 3A.

Accordingly, the first electrode sheet 30 includes the plurality of first inner lines 31, the first bridge line 37, and the first edge line 39. Each of the plurality of first inner lines 31 includes the first discharge electrode 35 and the first dielectric layer 33. Anodization of the first discharge electrode 35 forms the first dielectric layer 33. The first dielectric layer 33 encloses (or covers or buries) the first discharge electrode 35. The first bridge line 37 structurally connects the first inner lines 31 to each other.

The first inner line 31 includes a first discharge electrode 35 and the first dielectric layer 33. The first discharge electrode 35 supplies a power source to the discharge cell. The first discharge electrode 35 is enclosed (or covered or buried) inside the first dielectric layer 33. The first discharge electrode 35 includes the first discharge portions 35a and the first connection portion 35b.

Each of the first discharge portions 35a forms a closed curve. The first discharge hole 32 is surrounded by the first discharge portion 35a inside the first dielectric layer 33. The first connection portion 35b electrically connects the first discharge portions 35a to each other, and receives and transfers power to the discharge space. Here, the first discharge electrode 35 is the same (or substantially the same) metal as that of the metal oxide M_{X}O_{Y} of the first dielectric layer 33, which is formed by anodization. For example, the metal is selected from the group consisting of aluminum (Al), magnesium (Mn), zinc (Zn), and iron (Fe).

The first dielectric layer 33 encloses (or covers or buries) the first discharge electrode 35, and includes a plurality of first discharge holes 32. The dielectric layer 33 is a metal oxide M_{X}O_{Y} formed by anodizing the metal M of the first discharge electrode 35. For example, the first dielectric layer 33 is formed of a material selected from the group consisting of Al_{X}O_{Y}, Mg_{X}O_{Y}, Zn_{X}O_{Y}, and Fe_{X}O_{Y}. Here, X and Y are each a natural number.

The first dielectric layer 33 is formed from the first discharge electrode 35 to have a thickness (that may be predetermined). The first dielectric layer 33 may have the same shape as that of the first discharge electrode 35. For example, the first dielectric layer 33 may be formed by a plurality of dielectric layer lines, which have a shape corresponding to the first discharge portion 35a and the first connection portion 35b of the first discharge electrode 35.

The first bridge line 37 connects the first inner lines 31 for structural support thereof. The first bridge line 37 has a width smaller (or less or narrower) than that of the first inner line 31. A reason the first bridge line 37 is narrower in width than that of the first inner line 31 is that when the first electrode sheet 30 is formed by anodization, the first bridge line 37 is structurally connected to the first dielectric layer 33 of the first inner line 31, but is not electrically connected to the first discharge electrode 35.

The first edge line 39 is connected to one or more ends of the first inner lines 31 and an end of the bridge line 37. The first edge line 39 causes the first electrode sheet 30 to have a sheet shape (that may be predetermined).

Referring the FIG. 4, construction of the second electrode sheet 40 will be described in more detail. FIG. 4A is a perspective view showing an embodiment of the second electrode sheet 40, shown in FIG. 1. FIG. 4B is an enlarged view of a peripheral portion of a unit discharge hole in the second electrode sheet 40 shown in FIG. 4A. FIG. 4C is a cross-sectional view of the peripheral portion of the unit discharge hole taken along line L-L′ of FIG. 4A.

Accordingly, the second electrode sheet 40 includes the plurality of second inner lines 41, the second bridge line 47, and the second edge line 49. The plurality of second inner lines 41 include a second discharge electrode 45 and a second dielectric layer 43. Anodization of the second discharge electrode 45 forms the second dielectric layer 43. The second dielectric layer 43 encloses (or covers or buries) the second discharge electrode 45. The second bridge line 47 structurally connects the second inner lines 41 to each other.

The second inner line 41 includes a second discharge electrode 45 and the second dielectric layer 43. The second discharge electrode 45 supplies power to the discharge cell. The second discharge electrode 45 is enclosed (or covered or buried) inside the second dielectric layer 43. The second discharge electrode 45 includes the second discharge portions 45a and the second connection portion 45b.

Each of the second discharge portions 45a forms a closed curve. The second discharge hole 42 is surrounded by the second discharge portion 45a inside the second dielectric layer 43. The second connection portion 45b electrically connects the second discharge portions 45a to each other, and receives and transfers power to the discharge space. Here, the second discharge electrode 45 is the same metal as that of a metal oxide M_{X}O_{Y} of the second dielectric layer 43, which is formed by anodization. For example, the metal is selected from the group consisting of aluminum (Al), magnesium (Mn), zinc (Zn), and iron (Fe).

The second dielectric layer 43 encloses (or covers or buries) the second discharge electrode 45, and includes a plurality of second discharge holes 42. The dielectric layer 43 is a metal oxide M_{X}O_{Y} formed by anodizing the metal M of the second discharge electrode 45. For example, the second dielectric layer 43 is formed of a material selected from the group consisting of Al_{X}O_{Y}, Mg_{X}O_{Y}, Zn_{X}O_{Y}, and Fe_{X}O_{Y}. Here, X and Y are each a natural number.

The second dielectric layer 43 is formed from the second discharge electrode 45 to have a thickness (that may be predetermined). The second dielectric layer 43 may have the same (or substantially the same) shape as that of the second discharge electrode 45. For example, the second dielectric layer 43 may be formed by a plurality of dielectric layer lines, which have a shape corresponding to the second discharge portion 45a and the second connection portion 45b of the second discharge electrode 45.

The second bridge line 47 connects the inner lines for structural support. The second bridge line 47 has a width smaller (less or narrower) than that of the second inner line 41. A reason the second bridge line 47 is narrower in width than that of the second inner line 41 is that when the second electrode sheet 40 is formed by anodization, the second bridge line 47 is structurally connected to the second dielectric layer 43 of the second inner line 41, but is not electrically connected to the second discharge electrode 45.

The second edge line 49 is connected to one or more ends of the second inner line 41 and an end of the bridge line 47. The second edge line 49 causes the second electrode sheet 40 to have a sheet shape (that may be predetermined).

The first discharge electrode 35 and the second discharge electrode 45 are arranged to cross each other to allow a discharge between them. For example, in driving the plasma display panel, when the first discharge electrode 35 functions as a scan electrode during an address period and as a Y electrode during a sustain period, the second discharge electrode 45 functions as an address electrode during the address period and as an X electrode during the sustain period.

Referring back to FIG. 1 and FIG. 2, discharge spaces are formed inside the discharge holes 32 and 42 of the respective electrode sheets 30 and 40. Non-discharge spaces are formed outside of the discharge holes 32 and 42, namely, between the first inner lines 31 of the first electrode sheet 30 and the second inner lines 41 of the second electrode sheet 40, and between the first edge line 39 and the first inner line 31, and between the second edge line 49 and the second inner line 41. So as not to generate a discharge (or an erroneous discharge) in the non-discharge spaces, a first dielectric structure 50a is located in the non-discharge spaces of the first electrode sheet 30 and a second dielectric structure 50b is located in the non-discharge spaces of the second electrode sheet 40. The dielectric structures 50a and 50b prevent (or block or protect from) a discharge in the non-discharge space, which may deteriorate emission efficiency.

Furthermore, when the first and second dielectric structures 50a and 50b are formed by light-absorbing dielectric material (e.g., a black matrix), the dielectric structures reduce peripheral reflection.

As shown in FIG. 2, a first passivation layer 34 and a second passivation layer 44 are formed at the surfaces of the first and second dielectric layers 33 and 43, respectively, which protect the electrode during a discharge and reduce discharge voltage by a secondary electron emission.

In an embodiment of the present invention as shown in FIG. 5, a dielectric layer formed by anodization has a thin hole 63 having a diameter of several tens of nanometers. FIG. 5 shows a surface of an electrode sheet including a passivation layer 65. When a metal sheet is anodized, a surface of the dielectric layer 60 formed by anodization is divided into a thin hole layer 61 and a barrier layer 62. Here, a thin hole 63 is formed in the thin hole layer 61, but is not formed in the barrier layer 62.

A passivation layer 65 is uniformly formed on a surface of the dielectric layer 60, and the inside of the thin hole 63 is uniformly filled with the passivation layer 65.

The first passivation layer 34 and the second passivation layer 44 improve secondary electron emission characteristics, protect the discharge cells, and increase an internal voltage.

The following is a description of a method for manufacturing a plasma display panel according an embodiment of the present invention.

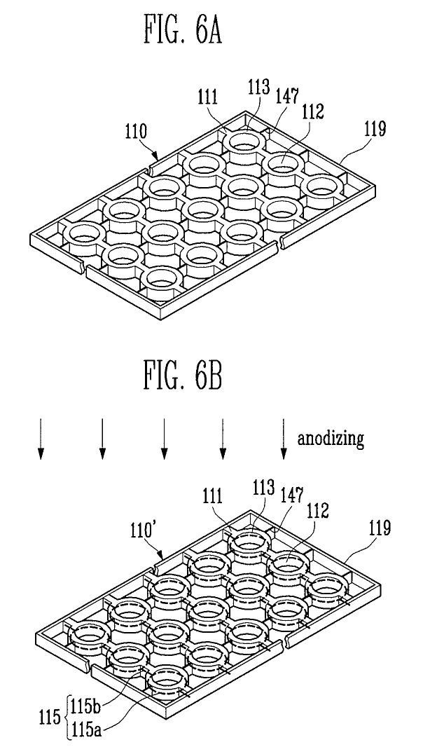

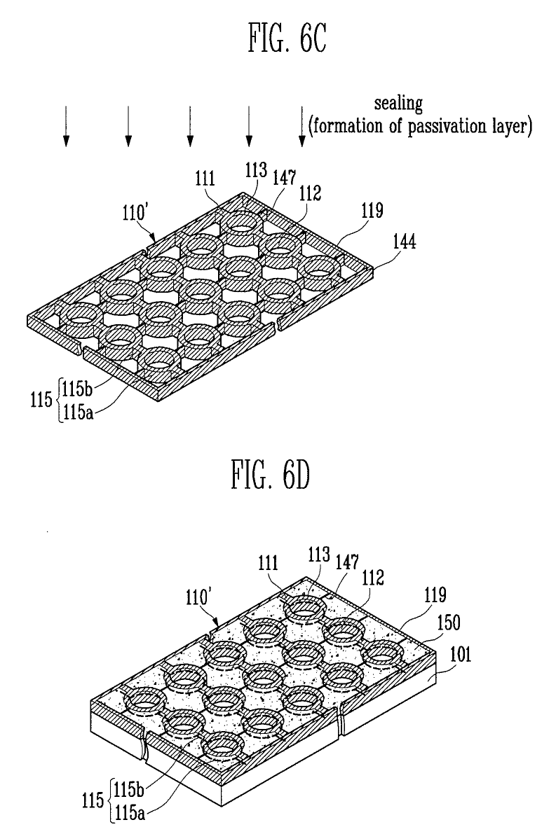

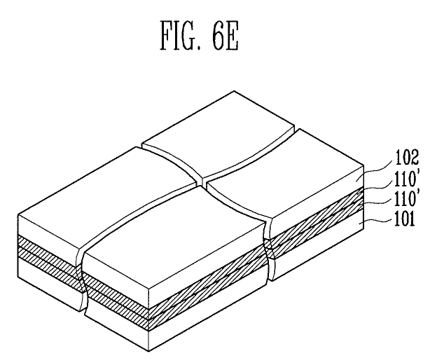

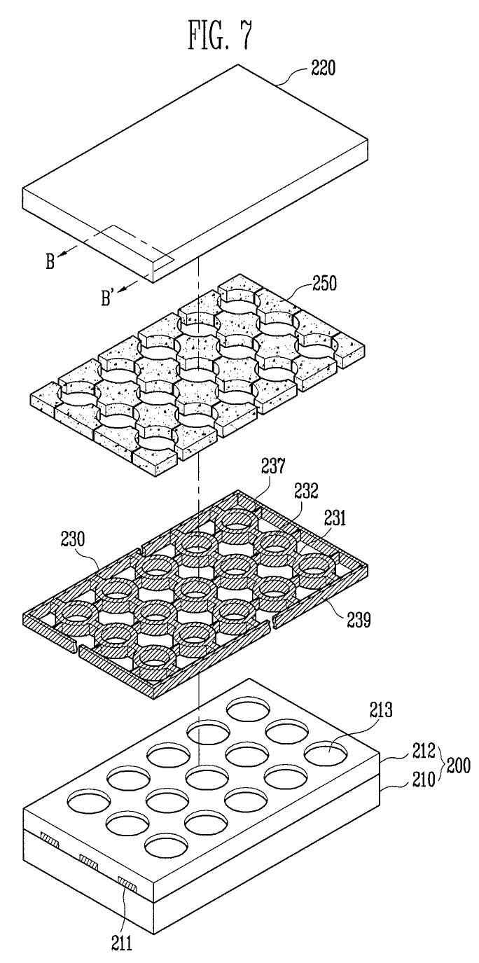

As shown in FIG. 6A, a metal sheet 110 is cut to form the inner lines 111, the edge lines 119, and the bridge lines 147. Discharge holes 112 are formed on the inner line 111. Here, the shape of the discharge hole 112 may be, but is not limited to, a circle. So as to support the shape of the electrode sheet during manufacturing, the bridge lines 147 connect the inner lines 111 to each other. The bridge lines 147 have a width smaller (less or narrower) than that of the inner lines (FIG. 6A).

Next, the metal sheet 110 is anodized. That is, the metal sheet 110 is anodized to form an electrode sheet 110′. Here, the electrode sheet 110′ includes a plurality of inner lines 111 and an edge line 119. The plurality of inner lines 111 include discharge electrodes 115 and a dielectric layer 113. The discharge electrodes 115 include a plurality of discharge portions 115a extending in one direction to form a closed curve and a connection portion 115b for electrically connecting the discharge portions 115a to each other. The dielectric layer 113 includes a discharge hole 112 through the closed curve of the discharge portions 115a. Anodization of the discharge electrode 115 forms the dielectric layer 113, and the edge line 119 forms an edge of the electrode sheets 110′ by which the ends of the inner lines 111 are connected. Here, anodization refers to an electrochemical oxidation of a metal surface for generating a stable oxide on the metal surface (FIG. 6B).

Then, a passivation layer 144 is formed on a surface of the electrode sheets 110′, as shown in FIG. 6C. The passivation layer 144 is formed by filling thin holes with passivation layer material by an electrolytic sealing method. Here, the electrolytic sealing method is a method capable of uniformly forming a layer of material over an entire surface. The electrolytic sealing method is a method of electrochemically introducing, depositing, and sealing inorganic matter in thin holes, through an AC-electrolyzing process by using metal salt as electrolytic bath (FIG. 6C).

Subsequently, at least one of the electrode sheets 110′ is positioned on the first substrate 101, as shown in FIG. 6D. Dielectric structures 150 are provided in non-discharge spaces between the inner lines 111 of the electrode sheets 110′ and between the edge lines 119 and the inner lines 111. The dielectric structures 150 may be formed by a pattern printing method and/or may be formed by a structure inserted into a non-discharge space. Otherwise, the electrode sheets 110′ may be coated by liquid dielectric material that is cured (FIG. 6D).

Thereafter, the first substrate 101 and at least one of the electrode sheets 110′ engage with the second substrate 102, as shown in FIG. 6E. The positions of grooves in which fluorescent layers are formed on the first substrate 101 and the second substrate 102 correspond to the positions of discharge grooves of the electrode sheets 110′, thereby forming discharge spaces between them.

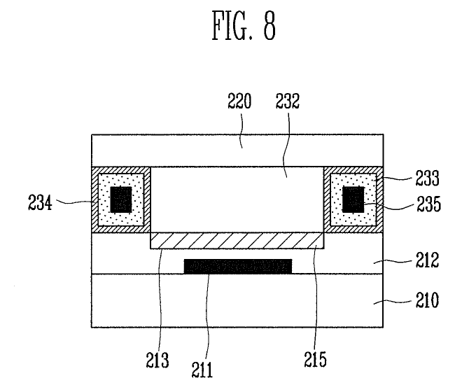

FIG. 7 is a perspective view showing a plasma display panel according to a second embodiment of the present invention. FIG. 8 is a cross-sectional view of the plasma display panel taken along line B-B′ of FIG. 7. Parts of the second embodiment corresponding to those of the first embodiment are designated by the same reference symbols and a more detailed description thereof is not provided, and parts that are different from the first embodiment will be described in more detail. With reference to FIG. 7 and FIG. 8, the plasma display panel includes a rear panel 200, a front substrate 220, and an electrode sheet 230.

The rear panel 200 and the front substrate 220 are arranged to be spaced apart and facing each other. The electrode sheet 230 is between the rear panel 200 and the front substrate 220. The rear panel 200 includes first discharge electrodes 211 and a first dielectric layer 212 on the rear substrate 210. The first discharge electrodes 211 are formed on an upper surface of the rear panel 200 facing the front substrate 220 to extend in a direction crossing the inner line 231. The dielectric layer 212 covers the first discharge electrodes 211. A groove 213 is formed on the first dielectric layer 212 to have a depth (that may be predetermined). Here, a fluorescent layer 215 is formed in the groove 213, as shown in FIG. 8. The groove 213 forms a lower surface of a discharge cell.

The electrode sheet 230 includes inner lines 231, bridge lines 237, and an edge line 239. Each of the inner lines 231 includes a second dielectric layer 233 and a second discharge electrode 235. The bridge line 237 connects the inner lines 231 to each other. The edge line 239 is connected to one or more ends of the inner lines 231 and an end of the bridge line 237. A plurality of discharge holes 232 are formed on the inner lines 231. Since the electrode sheet 230 is similar to (or substantially the same as) earlier embodiments, a detailed description thereof is not provided.

Discharge spaces are formed inside the discharge holes 232 of respective electrode sheets 230. Non-discharge spaces are formed outside the discharge holes 232, namely, between the inner lines 231, the bridge lines 237, and the edge line 239 of the electrode sheet 230, so as to prevent (or block or protect from) a discharge in the non-discharge spaces, a dielectric structure 250 is located in the non-discharge spaces. This prevents (or blocks or protects from) a discharge in the non-discharge space, which would deteriorate emission efficiency. Furthermore, when the dielectric structure 250 is formed by light-absorbing dielectric material (e.g., a black matrix), the dielectric structure functions to reduce peripheral reflection.

A passivation layer 234 is formed on a surface of the dielectric layer 233, which protects the electrode during a discharge and reduces discharge voltage by a secondary electron emission.

In an embodiment of the present invention, the passivation layer 234 is uniformly formed at a surface of the second dielectric layer 233, and the inside of the thin holes is filled with the passivation layer 234.

Each discharge space of the second embodiment of the present invention is defined by using the rear substrate 210 as a lower surface, the front substrate 220 as an upper surface, and the discharge hole 232 formed in the electrode sheet 230 as the inner wall surface. The inside of the discharge space is filled with discharge gas.

Discharges between the first discharge electrode 211 of the rear panel 200 and the second discharge electrode 235 of the electrode sheet 230 powered by an external power source drive the plasma display panel.

For example, when the external power source is applied to the first discharge electrode 211 and the second discharge electrode 235, the first discharge electrode 211 function as a scan electrode during an address period and as Y electrode during a sustain period, and the second discharge electrode 235 function as the address electrode during the address period and an X electrode during the sustain period. Thereby driving the plasma display panel.

Since the manufacturing method according to the second embodiment is similar that of the first embodiment, a detailed description thereof is omitted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. For example, in the second embodiment, the first discharge electrode can be manufactured in a form of an electrode sheet having a straight electrode line. Further, the size of a through hole, and a shape and a size of a code portion may be changed.

What is claimed is:

1. A plasma display panel, comprising:
a first electrode sheet between a first substrate and a second substrate facing the first substrate; and
a second electrode sheet disposed between the second substrate and the first electrode sheet,
wherein the first electrode sheet comprises a plurality of first inner lines, each of the first inner lines comprising a first discharge electrode and a first dielectric layer enclosing the first discharge electrode and being composed of an anodized material of the first discharge electrode, the first discharge electrode comprising a plurality of first discharge portions and a first connection portion coupling the first discharge portions along a first direction, each of the first discharge portions having a first closed curve surrounding a first discharge hole through the first closed curve,
wherein the second electrode sheet comprises a plurality of second inner lines, each of the second inner lines comprising a second discharge electrode and a second dielectric layer enclosing the second discharge electrode and being composed of an anodized material of the second discharge electrode, the second discharge electrode comprising a plurality of second discharge portions and a second connection portion coupling the second discharge portions along a second direction crossing the first direction, each of the second discharge portions having a second closed curve surrounding a second discharge hole through the second closed curve, and
wherein the first electrode sheet and the second electrode sheet are arranged so that the first discharge hole corresponds with the second discharge hole; and
a plurality of dielectric structures at non-discharge spaces of the first electrode sheet and the second electrode sheet.

2. The plasma display panel as claimed in claim 1, wherein the non-discharge spaces are between the first inner lines of the first electrode sheet and the second inner lines of the second electrode sheet.

3. The plasma display panel as claimed in claim 1, wherein the non-discharge spaces are between a first edge line, coupling an end of the first inner lines, and a second edge line coupling an end of the second inner lines.

4. The plasma display panel as claimed in claim 1, wherein each of the dielectric structures comprises a material selected from the group consisting of Al_{X}O_{Y}, Mg_{X}O_{Y}, Zn_{X}O_{Y}, and Fe_{X}O_{Y}, and wherein X and Y are each a natural number.

5. The plasma display panel as claimed in claim 1, wherein each of the dielectric structures has a light-absorbing color.

6. The plasma display panel as claimed in claim 1, further comprising a first passivation layer and a second passivation layer at surfaces of the first electrode sheet and the second electrode sheet, respectively.

7. The plasma display panel as claimed in claim 6, wherein each of the first and second passivation layers is on a surface and inside of a thin hole of a porous surface of the dielectric layer.

8. The plasma display panel as claimed in claim 6, wherein the first and second passivation layers are a dielectric material.

9. The plasma display panel as claimed in claim 6, wherein the first and second passivation layers are magnesium oxide (MgO).

10. The plasma display panel as claimed in claim 1, wherein the first electrode sheet comprises a first bridge line structurally connecting the first inner lines, and wherein the second electrode sheet comprises a second bridge line structurally connecting the second inner lines.

11. The plasma display panel as claimed in claim 8, wherein the first bridge line has a width less than that of at least one of the first inner lines, and wherein the second bridge line has a width less than that of at least one of the second inner lines.

12. The plasma display panel as claimed in claim 1, wherein the discharge electrodes comprise a material selected from the group consisting of aluminum (Al), zinc (Zn), and iron (Fe).

13. The plasma display panel as claimed in claim 1, wherein at least one of the first closed curve or the second closed curve is a circle.

14. The plasma display panel as claimed in claim 1, wherein a groove is in at least one surface of the first substrate or the second substrate, to correspond with at least one of the first discharge hole or the second discharge hole, and a fluorescent layer is disposed in the groove.

15. A plasma display panel, comprising:
a first substrate comprising a first discharge electrode and a first dielectric layer enclosing the first discharge electrode;
a second substrate facing the first substrate;
a first discharge electrode between the first substrate and the second substrate;
a first dielectric layer on the first substrate and covering the first discharge electrode; and
an electrode sheet disposed between the first discharge electrode and the second substrate,
wherein the electrode sheet comprises a plurality of inner lines and an edge line, each of the inner lines comprising a second discharge electrode and a second dielectric layer enclosing the second discharge electrode and being composed of an anodized material of the second discharge electrode, the second discharge electrode comprising a plurality of discharge portions and a connection portion electrically connecting the discharge portions along one direction, each of the discharge portions having a closed curve surrounding a discharge hole through the closed curve, the edge line forming an edge of the electrode sheet to couple ends of the inner lines; and
a plurality of dielectric structures at non-discharge spaces between the inner lines of the electrode sheet, and between the edge line and the inner lines.

16. The plasma display panel as claimed in claim 15, further comprising a passivation layer at a surface of the electrode sheet.

17. The plasma display panel as claimed in claim 16, wherein the passivation layer is on a surface and inside of a thin hole of a porous surface of the dielectric layer.

18. The plasma display panel as claimed in claim 15, further comprising another electrode sheet, wherein the another electrode sheet comprises a plurality of second inner lines and a second edge line, the plurality of second inner lines comprise the first discharge electrode and the first dielectric layer, and the second edge line couples ends of the second inner lines.

19. The plasma display panel as claimed in claim 15, wherein the electrode sheet comprises a bridge line structurally connecting the inner lines.

20. The plasma display panel as claimed in claim 19, wherein the bridge line has a width less than that of at least one of the inner lines.

21. The plasma display panel as claimed in claim 15, wherein the second discharge electrodes comprise a material selected from the group consisting of aluminum (Al), zinc (Zn), and iron (Fe).

22. The plasma display panel as claimed in claim 15, wherein the closed curve is a circle.

23. The plasma display panel as claimed in claim 15, wherein a groove is formed in a surface of the first substrate, to correspond with the discharge hole, and a fluorescent layer is disposed in the groove.

24. The plasma display panel as claimed in claim 16, wherein the passivation layer is a dielectric material.

25. The plasma display panel as claimed in claim 24, wherein the passivation layer is magnesium oxide (MgO).

26. A method for manufacturing a plasma display panel including an anodized electrode sheet, the method comprising:
cutting at least one metal sheet;
anodizing the metal sheet to form an electrode sheet comprising a plurality of inner lines and an edge line, the plurality of inner lines comprising a discharge electrode and a dielectric layer enclosing the discharge electrode and being composed of an anodized material of the discharge electrode, the discharge electrode comprising a plurality of discharge portions, each of the discharge portions having a closed curve surrounding a discharge hole through the closed curve and a connection portion for electrically connecting the discharge portions along one direction, the edge line forming an edge of the electrode sheet to couple ends of the inner lines;
positioning the electrode sheet on a first substrate;
forming a plurality of dielectric structures at non-discharge spaces between the inner lines of the electrode sheet, and between the edge line and the inner lines; and
adhering a second substrate to the first substrate and the electrode sheet.

27. The method as claimed in claim 26, wherein the dielectric structure is formed by a pattern printing method.

28. The method as claimed in claim 26, further comprising forming a passivation layer at a surface of the electrode sheet after the formation of the electrode sheet.

29. The method as claimed in claim 28, wherein the passivation layer is formed at the surface of the electrode sheet by an electrolytic sealing method.
